(19) United States
(12) Patent Application Publication
(10) Pub. No.: US 2014/0257912 A1
(43) Pub. Date: Sep. 11, 2014

(54) PRODUCT INVENTORY ALLOCATION

(71) Applicant: TARGET BRANDS, INC., Minneapolis, MN (US)

(72) Inventors: Ping Fong Hsieh, Plymouth, MN (US); Earl Stanley Sun, Chaska, MN (US); Daniel Willard Peterson, New Hope, MN (US)

(73) Assignee: Target Brands, Inc., Minneapolis, MN (US)

(21) Appl. No.: 13/793,705

(22) Filed: Mar. 11, 2013

(51) Int. Cl. G06Q 10/06

(52) U.S. Cl. CPC G06Q 10/06315
USPC 705/7.25

(57) ABSTRACT

Sales transaction data of products sold at a store of a retailer is employed to identify opportunities to reallocate product inventory among the products based on characteristics of sales of the products. The sales transaction data is employed to determine characteristics of product sales, including, e.g., sales volume and sell-through. The number of units of products inventoried in a store can be reallocated based on sales volume and sell-through of the products indicated by the sales transaction data. After reallocation to determine new inventory levels for the products, an estimate of sales performance for the products can be determined at the new inventory levels and the estimated sales can be compared to past actual sales measurements to determine the potential effect of changing the number of units of products allocated to inventory in a store in a retail chain of a retailer.

### TECHNICAL FIELD

This disclosure relates to systems and methods for managing and analyzing data related to the sale of one or more products in retail store outlets.

### BACKGROUND

Consumers may purchase various products via retail stores. More specifically, retail stores may represent the final point of sale (“POS”) before an end-user gains possession of a product. To this end, retail stores may stock and sell a wide variety of products, and may cater to large customer demands. For example, several modern retail stores cover areas exceeding 120,000 square feet (11,148 square meters). Larger versions of these retail stores, such as so-called “super stores,” may cover areas exceeding 170,000 square feet (or 15,793 square meters). As retail stores gain area and variety of products that they carry, the placement and arrangement of products within a retail store is becoming a more relevant, complex, and intricate inquiry. Additionally, improving the different products and the volume of each product that is allocated to different stores within a retail chain can be a significant factor in sales revenue and profitability for a retailer operating a large chain of stores.

### SUMMARY

Examples according to this disclosure employ past sales transaction data of a number of products sold at a store of a retailer to identify opportunities to reallocate product inventory among the products based on characteristics of sales of the products indicated by the sales transaction data. The sales transaction data can indicate, e.g., of a total number of a product actually stocked in inventory at the store, how many units sold and at what price each unit sold. This information can be employed to determine a number of important characteristics of product sales, including, e.g., sales volume and sell-through. Some examples according to this disclosure include reallocating units of products inventoried in a store based on sales volume and sell-through of the products indicated by past sales transaction data. After reallocation to determine new inventory levels for the products, an estimate of sales performance for the products can be determined at the new inventory levels and the estimated sales can be compared to past actual sales measurements to determine the potential effect of changing the number of units of products allocated to inventory in a store in the retail chain of the retailer.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that may be used for determining the potential effect of changing the number of units of products allocated to inventory in a store in the retail chain of the retailer.

FIG. 2 is a block diagram illustrating an example computing device that determines the potential incremental sales increase resulting from altering product inventory allocation in a store.

FIG. 3 is a flowchart illustrating one example method of determining the potential effect of altering product inventory allocation in a store of a retailer.

FIG. 4 is a graphical representation of information indicated by past sales transaction data for a number of products sold at a store of a retailer.

FIG. 5 is a conceptual diagram illustrating a number of groups into which products of a retailer are divided based on product sell-through and sales volume.

FIGS. 6A and 6B are graphical illustrations of the unit sales and sell-through for two products sold by a retailer.

FIG. 7 is a report representing the results of a product inventory reallocation process in accordance with this disclosure

### DETAILED DESCRIPTION

Examples according to this disclosure are directed to improving the manner in which product inventories are allocated in stores that are part of a chain of retail stores. Sales transaction data of products sold at a store of a retailer can be employed to identify opportunities to reallocate product inventory among the products based on characteristics of sales of the products indicated by the sales transaction data. The sales transaction data can indicate, of a total number of a product actually stocked in inventory at the store, how many units sold and at what price each unit sold. This information can be employed to determine a number of important characteristics of product sales, including, e.g., sales volume and sell-through. Sales volume can be defined as the number of units of a product sold at a store of the retailer. Sell-through is a measure of what proportion (e.g., percentage) of a product sales are at a full, e.g., “retail” price versus at a reduced, e.g., “clearance” price. Examples according to this disclosure include reallocating units of products inventoried in a store based on sales volume and sell-through of the products indicated by the past sales transaction data. After reallocation to determine new inventory levels for the products, an estimate of sales performance for the products can be determined at the new inventory levels and the estimated sales can be compared to past actual sales measurements to determine the potential effect of changing the number of units of products allocated to inventory in a store in the retail chain of the retailer.

Stocking the correct amount of a product in a store is a common challenge faced by retailers and other merchants. Retailers attempt to stock a particular product to match the demand for that product in a particular store. For example, retailers attempt to stock a number of units of a product in a store such that all or a threshold percentage of the units of the product will sell at full retail price, while not stocking too few such that potential sales of the product are never realized.

Retailers employ a variety of business analytics and other techniques to forecast the demand for products in stores and, based thereon, determine the particular manner in which to merchandise products in the stores. Merchandising a product may include the manner in which a product is advertised, the number of units of a product to stock in inventory at stores, the assortment of different products in a product category, and other characteristics of the manner in which a retailer ultimately presents a product to customers for sale.

One technique employed by retailers to improve product sales is store segmentation. To improve sales performance, e.g., by matching product offerings to customer demand, large retail chains that operate large numbers of stores at different locations will allocate different product assortments to different groups of stores within the chain. This strategy of merchandising retail products is often called store segmentation and/or clustering. Generally, all of the stores of the chain are broken up into a number of groups, which are sometimes referred to as clusters. Stores in the same cluster are considered to share some characteristic with one another.

Segmentation strategies allow retailers to, in effect, personalize product offerings to the particular customer demands of particular stores. Segmentation, however, may generally be associated with increased costs for the retailer. In addition, the level of granularity provided by a segmentation strategy, e.g. how many different assortments for different clusters of stores in the chain, will be proportional to segmentation associated costs.

Because product merchandising strategies like segmentation come at a cost, a retailer can benefit from metrics that indicate the potential benefit of implementing such strategies. As such, examples according to this disclosure are directed to measuring the potential benefit of changing the number of units of products allocated to different stores in a retail chain.

In one example, a computing device receives past sales data for a plurality of products associated with a retail store. The sales data indicates, for each of the products, an actual number of units stocked, a number of units sold at retail price, a number of units sold at reduced price, and a total number of units sold at any price. The computing device divides the products into a plurality of groups based on at least one of the number of units sold at retail price, the number of units sold at reduced price, and the total number of units sold at any price for each of the products. The computing device adds a number of units of the actual number of stocked units of one or more of the products of one of the plurality of groups to the actual number of stocked units of one or more of the products of another of the plurality of groups to determine a test number of stocked units of each of the one or more products. The computing device then determines potential total sales of all of the products based on the test number of stocked units of each of the one or more products.

The potential sales of the products based on the test number of stocked units can be compared to actual past sales to determine the potential incremental sales benefit that would result from reallocating the number of products stocked in the store. This process can be repeated for different groups of products, e.g., different product categories, different departments within a store, and the like. Additionally, the process can be repeated for all or a portion of the stores in the chain of retail stores operated by the retailer. The incremental sales increases determined in accordance with this disclosure can provide the retailer with a measurement of the potential benefit of changing the number of units of products allocated to different stores in the retail chain.

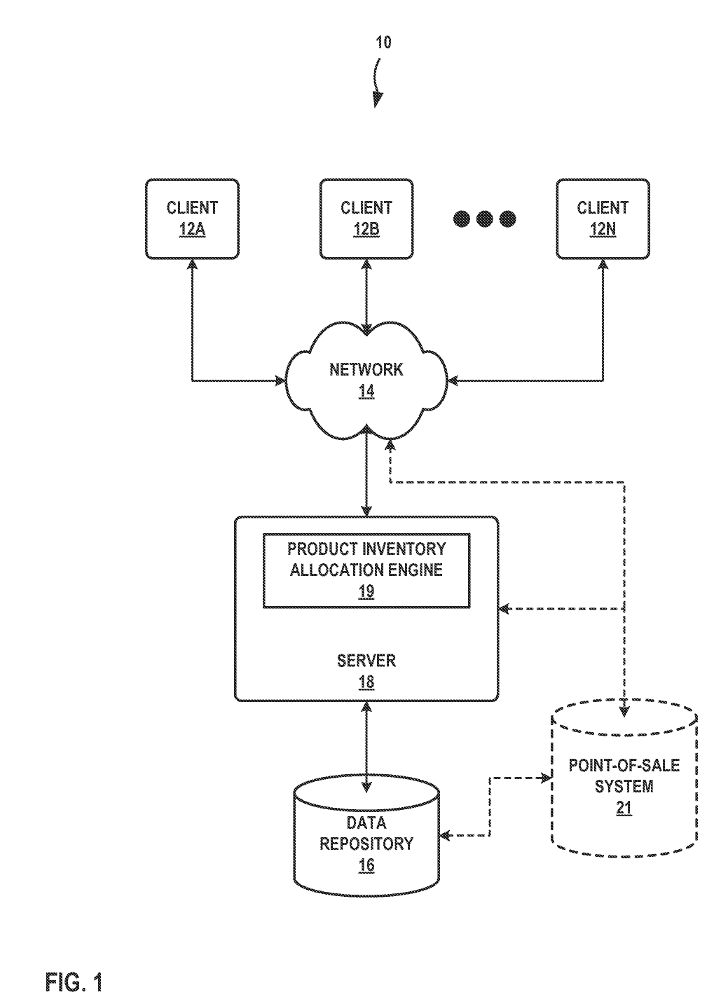

FIG. 1 is a block diagram illustrating example product allocation system (PAS) 10 including client computing devices 12A-12N (collectively “clients 12” or individually “client 12”), network 14, data repository 16, server 18, and point-of-sale (POS) system 21. Clients 12 are communicatively connected to data repository 16, server 18, and POS system 21 via network 14. Clients 12 and server 18 are configured to periodically communicate with one another over network 14 to track and store, e.g. in data repository 16, sales data associated with various products sold by a retailer, e.g. sales data retrieved from or communicated by POS system 21. Server 18 includes product inventory allocation engine 19, which may be employed in conjunction with the product sales data to determine the potential incremental sales increase resulting from altering product inventory allocation in a store. In this manner, system 10, and other systems according to this disclosure including similar capabilities may be employed to determine the potential effect of changing the number of units of products allocated to inventory in a store in the retail chain of the retailer.

In some examples, a retailer is an entity that provides services or retails merchandise through physical, tangible, non-Internet-based retail stores or through Internet-based stores. In the case of a retailer that sells products and services through physical, tangible, non-Internet-based retail stores, each store of the retailer can include retail floor space including a number of aisles. Each of the aisles can have shelf and/or rack space for displaying merchandise. In some stores, at least some of the aisles have end caps for displaying additional merchandise. Each of the stores includes one or more checkout lanes with cash registers at which customers may purchase merchandise. In some examples, the checkout lanes are staffed with cashiers. In general, vendors include entities, such as other retailers or suppliers, from which the retailer receives merchandise or services, either directly or indirectly. As used herein, the term merchandise broadly refers to any tangible item or service that a retailer provides to a customer.

Clients 12 may include any number of different portable electronic mobile devices, including, e.g., cellular phones, personal digital assistants (PDA's), laptop computers, portable gaming devices, portable media players, e-book readers, watches, as well as non-portable devices such as desktop computers. Clients 12 may include one or more input/output devices configured to allow user interaction with one or more programs configured to communicate with server 18 and product inventory allocation engine 19. For example, clients 12 may be client computers from which users access and interact with product inventory allocation engine 19. In one example, clients 12 may run a web browser that accesses and presents a web application executed by server 18 or another device and allows a user to analyze and process past sales data for products sold by the retailer to determine the potential incremental sales increase resulting from altering product inventory allocation in a store. In another example, clients 12 may execute an application outside of a web browser, e.g. an operating system specific application that accesses and presents information processed by product inventory allocation engine 19 on server 18 or another device. In another example, one or more of clients 12 may store and execute product inventory allocation engine 19 locally.

Network 14 may include one or more terrestrial and/or satellite networks interconnected to provide a means of communicatively connecting clients 12 to data repository 16 and server 18. For example, network 14 may be a private or public local area network (LAN) or Wide Area Network (WANs). Network 14 may include both wired and wireless communications according to one or more standards and/or via one or more transport mediums. For example, network 14 may include wireless communications according to one of the 802.11 or Bluetooth specification sets, or another standard or proprietary wireless communication protocol. Network 14 may also include communications over a terrestrial cellular network, including, e.g. a GSM (Global System for Mobile Communications), CDMA (Code Division Multiple Access), EDGE (Enhanced Data for Global Evolution) network. Data transmitted over network 14, e.g., from clients 12 to data repository 16 may be formatted in accordance with a variety of different communications protocols. For example, all or a portion of network 14 may be a packet-based, Internet Protocol (IP) network that communicates data from clients 12 to data repository 16 in Transmission Control Protocol/Internet Protocol (TCP/IP) packets, over, e.g., Category 5, Ethernet cables.

Data repository 18 and/or POS system 20 may each include, e.g., a standard or proprietary electronic database or other data storage and retrieval mechanism. For instance data repository 18 and/or POS system 20 may each include one or more databases, such as relational databases, multi-dimensional databases, hierarchical databases, object-oriented databases, or one or more other types of databases. Data repository 18 and/or POS system 20 may be implemented in software, hardware, and combinations of both. For example, data repository 18 and/or POS system 20 may include proprietary database software stored on one of a variety of storage mediums on a data storage server connected to network 14 and configured to store information associated with sales of products or other items at various store locations of a retailer. Storage media included in or employed in cooperation with data repository 18 and/or POS system 20 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Data repository 16 and/or POS system 21 may store information associated with sales of products and other items of the retailer. Examples of such information may include past actual sales transactions for the various products sold by the retailer at a number of locations, e.g., a number of stores in a number of different geographical locations. In one example, POS system 21 receives and processes sales data associated with customer transactions of the retailer at various locations of the retailer. Server 18 may periodically retrieve raw POS sales transaction data from POS system 21 and may store the data or process and then store the data in data repository 16. In another example, POS system 21 may be configured to periodically “push” the sales data over network 14 to server 18 and/or data repository 16.

Server 18 includes product inventory allocation engine 19, which may be employed, as described below, to determine the potential incremental sales increase resulting from altering product inventory allocation in a store. Server 18 may be any of several different types of network devices. For example, server 18 may include a data processing appliance, web server, specialized media server, personal computer operating in a peer-to-peer fashion, or another type of network device. Product inventory allocation engine 19 may be implemented in hardware, software, or a combination of both and may include one or more functional modules configured to execute various functions attributed to product inventory allocation engine 19. Additionally, although example system 10 of FIG. 1 includes one server 18, other examples may include a number of collocated or distributed servers configured to process sales and other types of data associated with products and other items sold by the retailer and stored in data repository 16 individually or in cooperation with one another.

Although data repository 16, server 18, and POS system 21 are illustrated as separate components in example system 10 of FIG. 1, in other examples the components may be combined or may each be distributed amongst more than one device. For example, server 18 may store data repository 16 and control the repository to periodically retrieve sales data from POS system 21 over network 14. In another example, data repository 16 and/or POS system 21 may be distributed among a number of separate devices, e.g. a number of database servers, and server 18 may include a number of co-located or distributed servers configured to operate individually and/or in cooperation with one another and with the various devices comprising data repository 16 and/or POS system 21.

Regardless of the particular configuration of system 10, or other example systems according to this disclosure, the system may be employed to determine the potential incremental sales increase resulting from altering product inventory allocation in a store. In one example, product inventory allocation engine 19 receives past sales data for a plurality of products associated with a retail store. For example, product inventory allocation engine 19 can receive the past sales data from POS system 21 and/or data repository 16. In one example, actual sales transaction data is collected and stored by POS system 21. Periodically, POS system 21 communicates collected sales data to data repository 16, which stores the sales data as past sales data for one or more products sold by the retailer. In such a case, product inventory allocation engine 19 can receive the past sales data stored by data repository 16, e.g., for a particular time period in the past like the past week, month, or year.

The sales data for the products, regardless of how it is collected or where it is stored, indicates an actual number of units stocked, a number of units sold at retail price, a number of units sold at reduced price, and a total number of units sold at any price for each of the products associated with the retail store. The sales data also includes actual total sales of all the products. A reduced price of a product is less than a retail price of the product. Additionally, a total number of units of a product sold at any price may, in some examples, be equal to a sum of a number of units of the product sold at retail price and the number of units of the product sold at reduced price.

Past sales data associated with products of the retailer indicates a variety of information about the sales transaction of the products in stores. In some examples, the retailer may be an entity that retails merchandise through physical, tangible, non-Internet-based retail stores. The retailer's inventory may include products on hand at a physical store and thereby available in one location for sale to customers.

Product inventory allocation engine 19 divides the products into a plurality of groups based on at least one of the number of units sold at retail price, the number of units sold at reduced price, and the total number of units sold at any price for each of the products. Product inventory allocation engine 19 adds a number of units of the actual number of stocked units of one or more of the products of one of the plurality of groups to the actual number of stocked units of one or more of the products of another of the plurality of groups to determine a test number of stocked units of each of the one or more products. Product inventory allocation engine 19 then determines potential total sales of all of the products based on the test number of stocked units of each of the one or more products.

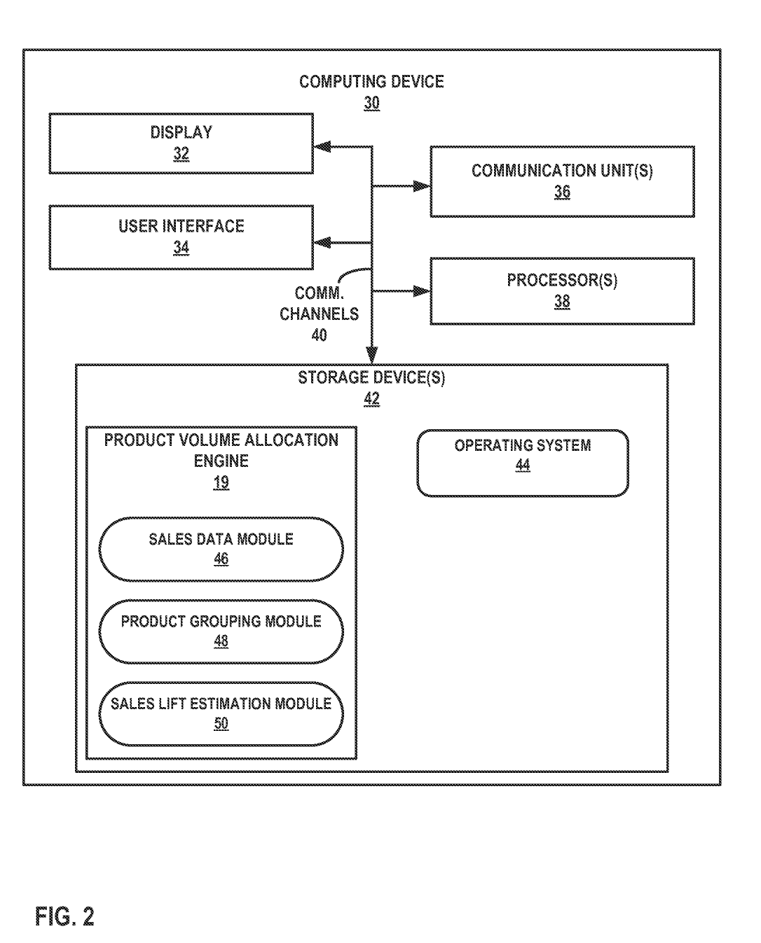

FIG. 2 is a block diagram illustrating an example computing device 30 that may be configured to determine the potential incremental sales increase resulting from altering product inventory allocation in a store. FIG. 2 illustrates only one example of computing device 30, and many other examples of computing device 30 may be used in other instances. In addition, although discussed with respect to one computing device 30, one or more components and functions of computing device 30 may be distributed among multiple computing devices 30.

Computing device 30 may, in certain examples, be substantially similar to server device 18 of FIG. 1. As such, examples of computing device 30 may include, but are not limited to, various types of network devices such as a data processing appliance, web server, specialized media server, personal computer operating in a peer-to-peer fashion, or another type of network device. Additional examples of computing device 30 may include, but are not limited to, computing devices such as desktop computers, workstations, network terminals, and portable or mobile devices such as personal digital assistants (PDAs), mobile phones (including smart phones), tablet computers, laptop computers, netbooks, ultrabooks, and others. In this manner, computing device 30 may be substantially similar to one of client devices 12 of FIG. 1.

As shown in the example of FIG. 2, computing device 30 includes display 32, user interface 34, one or more communication units 36, one or more processors 38, and one or more storage devices 42. As illustrated, computing device 30 further includes product inventory allocation engine 19 and operating system 44. Product inventory allocation engine 19 includes sales data module 46, product grouping module 48, and sales lift estimation module 50. Each of components 32, 34, 36, 38, and 42 may be interconnected (physically, communicatively, and/or operatively) for inter-component communications. In some examples, communication channels 40 may include a system bus, network connection, inter-process communication data structure, or any other channel for communicating data. As one example in FIG. 2, components 32, 34, 36, 38, and 42 may be coupled by one or more communication channels 40. Product inventory allocation engine 19, sales data module 46, product grouping module 48, sales lift estimation module 50, and operating system 44 may also communicate information with one another as well as with other components of computing device 30.

Display 32 may be a liquid crystal display (LCD), e-ink, organic light emitting diode (OLED), or other display. Display 32 may present the content of computing device 30 to a user. For example, display 32 may display the output of product inventory allocation engine 19 executed on one or more processors 38 of computing device 30, confirmation messages, indications, or other functions that may need to be presented to a user. In some examples, display 32 may provide some or all of the functionality of a user interface of computing device 30. For instance, display 32 may be a touch-sensitive and/or presence-sensitive display that can display a graphical user interface (GUI) and detect input from a user in the form of user input gestures using capacitive or inductive detection at or near the presence-sensitive display.

User interface 34 may allow a user of computing device 30 to interact with computing device 30. Examples of user interface 34 may include, but are not limited to, a keypad embedded on computing device 30, a keyboard, a mouse, a roller ball, buttons, or other devices that allow a user to interact with computing device 30. In some examples, computing device 30 may not include user interface 34, and the user may interact with computing device 30 with display 32 (e.g., by providing various user gestures). In some examples, the user may interact with computing device 30 with user interface 34 and display 32.

Computing device 30, in some examples, also includes one or more communication units 36. Computing device 30, in one example, utilizes one or more communication units 36 to communicate with external devices (e.g., clients 12 of FIG. 1) via one or more networks, such as one or more wireless networks, one or more cellular networks, or other types of networks. One or more communication units 36 may be a network interface card, such as an Ethernet card, an optical transceiver, a radio frequency transceiver, or any other type of device that can send and receive information. Other examples of such network interfaces may include Bluetooth, 3G and WiFi radio computing devices as well as Universal Serial Bus (USB).

One or more processors 38 (hereinafter “processors 38”), in one example, are configured to implement functionality and/or process instructions for execution within computing device 30. For example, processors 38 may be capable of processing instructions stored at one or more storage devices 42, which may include, in some examples, instructions for executing functions attributed to product inventory allocation engine 19 and the modules thereof. Examples of processors 38 may include any one or more of a microprocessor, a controller, a digital signal processor (DSP), an application specific integrated circuit (ASIC), a field-programmable gate array (FPGA), or equivalent discrete or integrated logic circuitry.

One or more storage devices 42 (hereinafter “storage devices 42”) may be configured to store information within computing device 30 during operation. Storage devices 42, in some examples, may be described as a computer-readable storage medium. In some examples, storage devices 42 may be a temporary memory, meaning that a primary purpose of one or more storage devices 42 is not long-term storage. Storage devices 42 may, in some examples, be described as a volatile memory, meaning that storage devices 42 do not maintain stored contents when the computer is turned off. Examples of volatile memories include random access memories (RAM), dynamic random access memories (DRAM), static random access memories (SRAM), and other forms of volatile memories known in the art. In some examples, storage devices 42 may be used to store program instructions for execution by one or more processors 38. Storage devices 42, for example, may be used by software or applications running on computing device 30 (e.g., product inventory allocation engine 19) to temporarily store information during program execution.

Storage devices 42, in some examples, also include one or more computer-readable storage media. Storage devices 42 may be configured to store larger amounts of information than volatile memory. Storage devices 42 may further be configured for long-term storage of information. In some examples, storage devices 42 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

As illustrated in FIG. 2, computing device 30 may include product inventory allocation engine 19. Product inventory allocation engine 19 includes sales data module 46, product grouping module 48, and sales lift estimation module 50. Sales data module 46 of product inventory allocation engine 19 may be configured to retrieve, receive, or otherwise reference actual sales transaction data corresponding to sales of products or other items at a number of different stores of a retailer. Sales data module 46 may, for example, retrieve sales data from a data repository like data repository 16 of FIG. 1.

Product grouping module 48 of product inventory allocation engine 19 is configured to divide the products into a number of groups based on characteristics of sales of the products indicated by the sales data. For example, product grouping module 48 is configured to divide the products into a number of groups based on at least one of the number of units sold at retail price, the number of units sold at reduced price, and the total number of units sold at any price for each of the products.

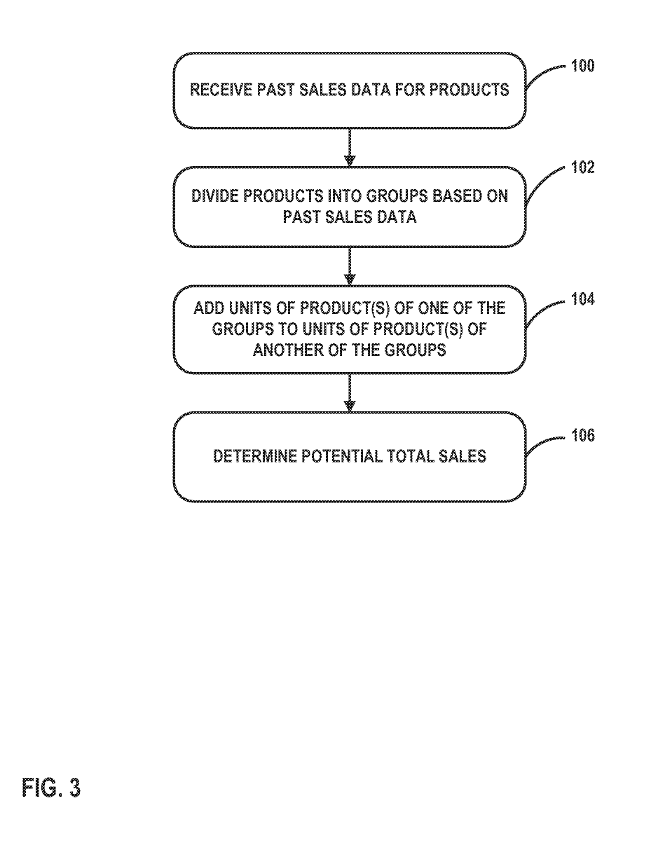

Sales lift estimation module 50 is configured to reallocate inventory of the products in a store among the different groups into which the products are divided by product grouping module 48. For example, sales lift estimation module 50 is configured to add a number of units of the actual number of stocked units of one or more of the products of one of the groups to the actual number of stocked units of one or more of the products of another of the groups to determine a test number of stocked units of each of the one or more products. Sales lift estimation module 50 is also configured to determine potential total sales of all of the products based on the test number of stocked units of each of the one or more products. In some examples, sales lift estimation module 50 compares the potential total sales of the products to actual past sales to determine the potential incremental sales benefit that would result from reallocating the number of products stocked in the store. The functions of sales data module 46, product grouping module 48, and sales lift estimation module 50 of product inventory allocation engine 19 are described in greater detail with reference to FIGS. 3-7 below.

Although shown as separate components in FIG. 2, in some examples, one or more of product inventory allocation engine 19, sales data module 46, product grouping module 48, and sales lift estimation module 50 may be part of the same module. In some examples, one or more of product inventory allocation engine 19, sales data module 46, product grouping module 48, and sales lift estimation module 50 may be formed in a common hardware unit. In some instances, one or more of product inventory allocation engine 19, sales data module 46, product grouping module 48, and sales lift estimation module 50 may be software and/or firmware units that are executed on processors 38. In general, the modules of product inventory allocation engine 19 are presented separately for ease of description and illustration. However, such illustration and description should not be construed to imply that these modules of product inventory allocation engine 19 are necessarily separately implemented, but can be in some examples.

Additionally, although the foregoing examples have been described with reference to product inventory allocation engine 19 including sales data module 46, product grouping module 48, and sales lift estimation module 50, in other examples such function/processing engines or other mechanisms configured to operate in accordance with the disclosed examples may be physically and/or logically differently arranged. For example, product inventory allocation engine 19 may include a product grouping module and sales lift estimation module, in which one or both of the two modules are configured to retrieve or otherwise reference sales data, e.g., retrieved by computing device 30 from a data repository like data repository 16 of FIG. 1. A wide variety of other logical and physical arrangements are possible in order to implement the functionality attributed to the example of product inventory allocation engine 19 illustrated in FIGS. 1 and 2.

Computing device 30 may include operating system 44. Operating system 44, in some examples, controls the operation of components of computing device 30. For example, operating system 44, in one example, facilitates the communication of product inventory allocation engine 19 with processors 38, display 32, user interface 34, and communication units 36.

Computing device 30 may include additional components not shown in FIG. 2. For example, computing device 30 may include a battery to provide power to the components of computing device 30. Similarly, the components of computing device 30 may not be necessary in every example of computing device 30. For instance, in certain examples computing device 30 may not include display 32.

As described above, examples according to this disclosure employ sales transaction data of products sold at a store of a retailer to identify opportunities to reallocate product inventory among the products based on characteristics of sales of the products gleaned from the sales transaction data. The sales transaction data can indicate, of a total number of a product actually stocked in inventory at the store, how many units sold and at what price each unit sold. This information can be employed to determine a number of important characteristics of product sales, including, e.g., sales volume and sell-through. Sales volume can be defined as the number of units of a product sold at a store of the retailer. Sell-through is a measure of what proportion (e.g., percentage) of a product sales are at a full, e.g., “retail” price versus at a reduced, e.g., “clearance” price. Examples according to this disclosure include reallocating units of products inventoried in a store based on sales volume and sell-through of the products indicated by past sales transaction data. After reallocation to determine new inventory levels for the products, an estimate of sales performance for the products can be determined at the new inventory levels and the estimated sales can be compared to past actual sales measurements to determine the potential effect of changing the number of units of products allocated to inventory in a store in the retail chain of the retailer.

FIG. 3 is a flowchart illustrating one example method of determining the potential effect of altering product inventory allocation in a store of a retailer. The method of FIG. 3 includes receiving past sales data for products associated with a retail store (100), dividing the products into a plurality of groups based on characteristics of sales of the products indicated by the past sales data (102), adding units of product(s) of one of the groups to units of product(s) of another of the groups to determine a test number of stocked units of each of the products (104), and determining potential total sales of all of the products based on the test number of stocked units of each of the one or more products (106).

The operations illustrated in the example of FIG. 3 are described below as executed by product inventory allocation engine 19 of computing device 30, including sales data module 46, product grouping module 48, and sales lift estimation module 50. However, these and other operations in accordance with examples of this disclosure can be carried out by other computing devices including different physical and logical configurations than computing device 30.

The method of FIG. 3 includes receiving past sales data for products associated with a retail store (100). In one example, sales data module 46 of product inventory allocation engine 19 is configured to retrieve, receive, or otherwise reference actual sales transaction data corresponding to sales of products or other items at a number of different stores of a retailer. For example, sales data module 46 can retrieve sales data from POS system 21 and/or data repository 16.

Actual sales data, wherever from and however retrieved, includes data indicating characteristics of the sales of the products at the store of the retailer. For example, past sales data retrieved by sales data module 46 indicates actual number of units stocked, number of units sold at retail price, number of units sold at reduced price, and total number of units sold at any price for each of the products. Additionally, in one example, past sales data retrieved by sales data module 46 indicates actual total sales of all of the products. The “reduced” price of a product is less than a “retail” price of the product. Additionally, the total number of units of a product sold at any price is equal to the sum of the number of units of the product sold at retail price and the number of units of the product sold at reduced price.

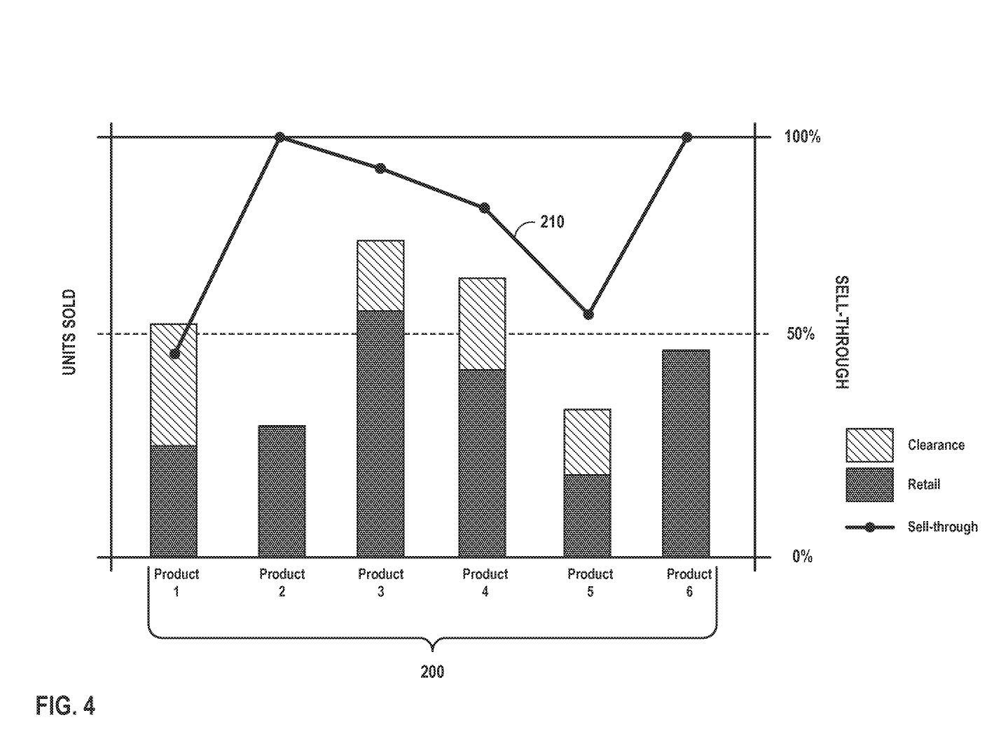

FIG. 4 is a graphical illustration of example information indicated by past sales data for products sold at a store of the retailer. In one example, FIG. 4 illustrates information that is included in past sales data retrieved by sales data module 46. The graphical illustration of FIG. 4 includes histogram 200 of units of six products sold at the store of the retailer. Where applicable, the number of units sold is divided into two different types of sales including sales at retail price and sales at a reduced or, in this case, clearance price. For example, for products 1, 3, 4, and 5, histogram 200 illustrates that a portion of the units sold of each product were sold at full retail price, while the remaining units were sold at reduced clearance price. For products 2 and 6, on the other hand, histogram 200 in FIG. 3 illustrates that all units sold for each product were sold at full retail price.

Curve 210 of FIG. 4 indicates the sell-through of each of the six products represented. Sell-through is a measure of what proportion (e.g., percentage) of a product unit sales are at a full, e.g., “retail” price versus at a reduced, e.g., “clearance” price. In one example, the sell-through for a product sold at a store of a retailer is equal to the number of units of the product sold at retail price divided by the total number of units sold. In other words, the sell-through for the product sold at the store is equal to the number of units of the product sold at retail price divided by the sum of the number of units of the product sold at retail price and the number of units of the product sold at reduced (e.g. clearance) price. For example, in FIG. 4, product 1 has a sell-through of just under 50%, because the number of units sold at retail price is just under 50% of the total number of units sold including units sold at retail and at clearance.

Products 2 and 6, in contrast to products 1 and 3-5, have a sell-through of 100%. The sell-through of products 2 and 6 is attributable to the fact that none of the units sold of either product sold at clearance, as represented in FIG. 4. Thus, for both products 2 and 6, the number of units sold at retail price is equal to the total number of units sold and the sell-through of each product is therefore 100%.

Referring again to FIG. 3, the example method includes dividing the products into a plurality of groups based on characteristics of sales of the products indicated by the past sales data (102). In one example, product grouping module 48 of product inventory allocation engine 19 is configured to divide the products into a number of groups based on characteristics of sales of the products indicated by the sales data. For example, product grouping module 48 is configured to divide the products into a number of groups based on at least one of the number of units sold at retail price, the number of units sold at reduced price, and the total number of units sold at any price for each of the products.

In one example, dividing, product grouping module 48 of product inventory allocation engine 19 divides all of the products into two groups comprising high sell-through products and low sell-through products. The high sell-through products include one or more of the products with a sell-through that is greater than or equal to a sell-through threshold. The low sell-through products include one or more of the products with a sell-through that is less than the sell-through threshold.

In one example, product grouping module 48 analyzes the past sales data and determines the sell-through for each of the products by calculating the number of units of the product sold at retail price divided by the total number of units sold. Product grouping module 48 compares the sell-through of each product to a sell-through threshold and, based on the comparison, divides the products into a high sell-through group and a low sell-through group. In one example, the sell-through threshold is equal to 10% such that products with a sell-through of greater than or equal to 10% are designated as high sell-through products and products with a sell-through of less than 10% are designated as low sell-through products.

In one example, product grouping module 48 of product inventory allocation engine 19 also divides all of the products into two groups comprising high-volume products and low-volume products. The high-volume products include one or more of the products with a sales volume that is greater than or equal to a sales volume threshold. The low-volume products include one or more of the products with a sales volume that is less than the sales volume threshold. Sales volume is equal to a total number of units of a product sold at any price divided by a total number of units of all of the products sold.

In one example, product grouping module 48 analyzes the past sales data and determines the sales volume for each of the products by calculating the total number of units of the product sold at any price (e.g. including at full retail and at reduced price) divided by a total number of units of all of the products sold. Product grouping module 48 compares the sales volume of each product to a sales volume threshold and, based on the comparison, divides the products into a high-volume group and a low-volume group. In one example, the sales volume threshold is equal to 10% such that products with a sales volume of greater than or equal to 10% are designated as high-volume products and products with a sales volume of less than 10% are designated as low-volume products.

In one example, product grouping module 48 can also group the high sell-through products, the low sell-through products, the high-volume products, and the low-volume products into a number of groups. For example, product grouping module 48 groups the high sell-through products, the low sell-through products, the high-volume products, and the low-volume products into four groups, including: a first group including low sell-through and low-volume products; a second group including low sell-through and high-volume products; a third group including high sell-through and low-volume products; and a fourth group including high sell-through and high-volume products.

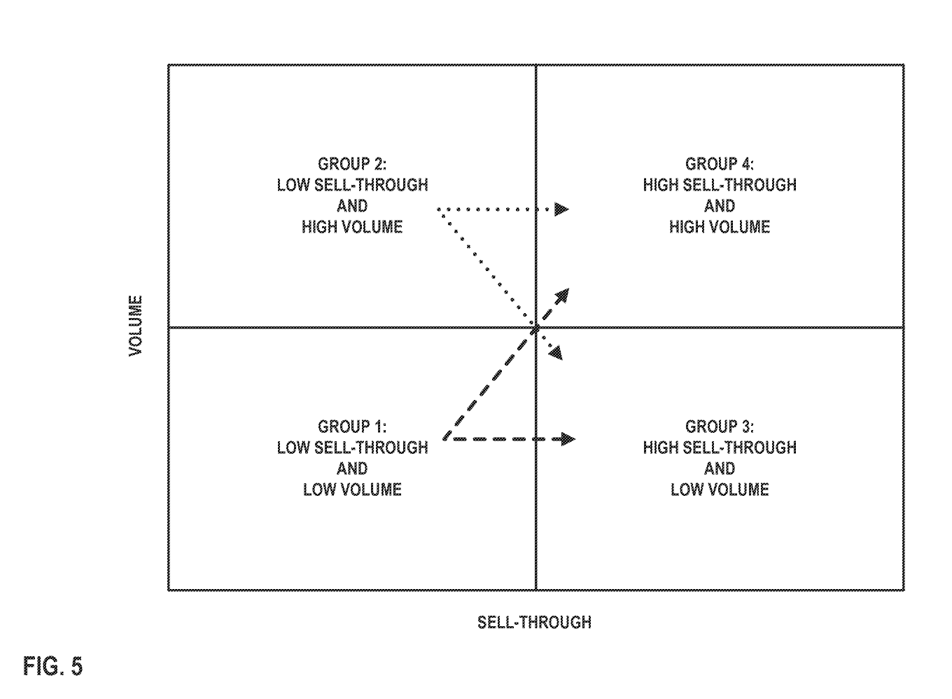

The foregoing example process of dividing a plurality of products sold at a store of a retailer into groups of high sell-through products, the low sell-through products, the high-volume products, and the low-volume products and then grouping the products into four groups, including: a first group including low sell-through and low-volume products; a second group including low sell-through and high-volume products; a third group including high sell-through and low-volume products; and a fourth group including high sell-through and high-volume products is graphically illustrated in the conceptual diagram of FIG. 5.

In FIG. 5, starting in the lower-left quadrant, group 1 includes low sell-through and low-volume products. In the upper-left quadrant, group 2 includes low sell-through and high-volume products. In the lower-right quadrant, group 3 includes high sell-through and low-volume products. Finally, in the upper-right quadrant, group 4 includes high sell-through and high-volume products.

Referring again to FIG. 3, the example method includes adding units of product(s) of one of the groups to units of product(s) of another of the groups to determine a test number of stocked units of each of the products (104). In one example, sales lift estimation module 50 is configured to reallocate inventory of the products in the store among the different groups into which the products are divided by product grouping module 48. For example, sales lift estimation module 50 is configured to add a number of the actual stocked units of one or more of the products of one of the four groups of FIG. 5 to the number of actual stocked units of one or more of the products of another of the four groups to determine a test number of stocked units of each of the products.

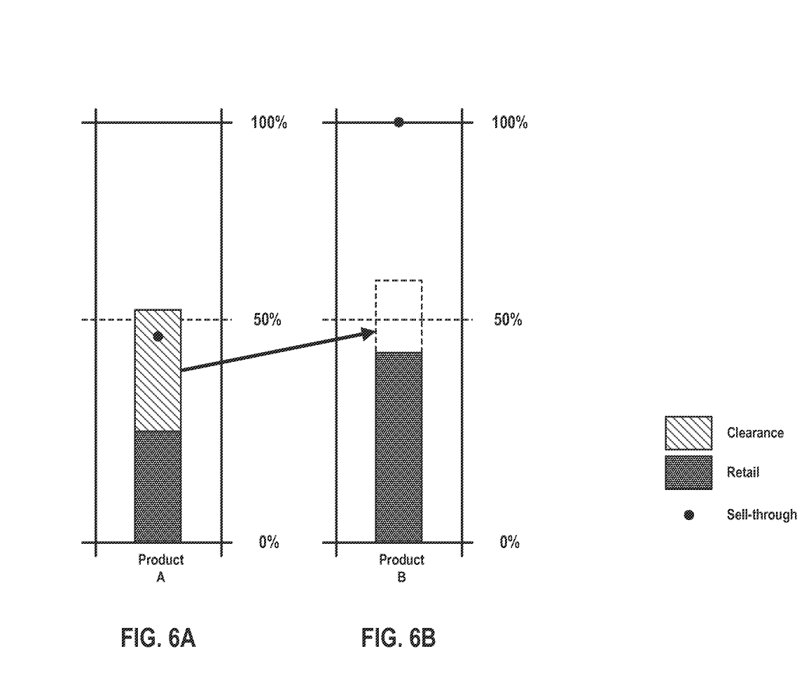

As noted above, examples according to this disclosure include identifying opportunities to reallocate product inventory among the products based on characteristics of sales of the products gleaned from past sales transaction data. One way in which such opportunities can be identified is by examining the sales volume and sell-through of products sold at the store of the retailer. FIGS. 6A and 6B illustrate the unit sales and sell-through for two products, product A and product B. In this example, past sales data for product A indicates that the product sold a little under 50% of the total units at retail price, while the remaining units sold at clearance. The sales data for product B, on the other hand, indicates that 100% of the units of the product sold at the store sold at retail price.

The less than 50% sell-through of product A can be interpreted as over-stocking the product in the store. For example, demand for product A at full retail price was only sustained for the product until less than 50% of the stocked units sold, at which time it may have been necessary to reduce the price to sell the remaining inventory.

The 100% sell-through of product B, on the other hand, can be interpreted as under-stocking the product in the store. For example, the limit of the demand for product B at full retail price may have never been reached, as all of the units sold at full price before a reduction in demand was indicated by reducing the price of the product.

A comparison of the sales of product A and product B may, in one example, identify an opportunity for reallocating the inventory of one of the products to the other to increase sales performance. For example, all or a portion of the units of product A stocked can be reallocated to the units of product B stocked in the store. In such a case, it may be estimated that all or a substantial portion of the increased inventory of product B will sell at full retail price, which may increase total sales performance of products A and B.

FIGS. 6A and 6B are meant to illustrate the manner in which product inventory can be reallocated to increase sales performance of a number of products in a store. The example of FIGS. 6A and 6B refer to consideration of sell-through of two products. However, in other examples according to this disclosure, additional product sales characteristics, e.g. sales volume, and more than two products may be considered in the process of reallocating inventory and estimating incremental sales increases based on the reallocated inventory levels.

For example, sales lift estimation module 50 of product inventory allocation engine 19 adds a number of the actual number of stocked units of one or more of the products of the first group and the second group illustrated in FIG. 5 to the actual number of stocked units of the products of the third group and the fourth group of FIG. 5 to determine a test number of stocked units of each of the one or more products. Thus, in one example, sales lift estimation module 50 reallocates inventory of the low sell-through and low-volume products (group 1) and the low sell-through and high-volume products (group 2) to the inventory of the high sell-through and low-volume products (group 3) and the high sell-through and high-volume products (group 4). Thus, in this example, sales lift estimation module 50 reduces the number stocked units of the low sell-through and low-volume products (group 1) and the low sell-through and high-volume products (group 2) and increases the number of stocked units of the high sell-through and low-volume products (group 3) and the high sell-through and high-volume products (group 4) in equal proportion. This reallocation process is illustrated graphically in FIG. 5 by the dashed and dotted lines showing inventory from group 1 and group 2 moving to inventory for group 3 and group 4.

The number of units reallocated, e.g. from groups 1 and 2 to groups 3 and 4, may be determined by sales lift estimation module 50 based on the number of units of the products, the inventory of which is being reallocated to other products, sold at reduced price. In one example, sales lift estimation module 50 determines or sets the number of the actual number of stocked units of product(s) of group 1 and group 2 that is added to the actual number of stocked units of the product(s) of group 3 and group 4 as equal to 50% of the number of units of the products in group 1 sold at reduced price and 100% of the number of units of the products in group 2 sold at reduced price. In such an example, if group 1 included 100 units and group 2 include 75 units sold at clearance, sales lift estimation module 50 may determine that a total of 125 units from group 1 and group 2 (50% of 100 units of group 1 plus 100% of units of group 2) is added to the number of stocked units of product(s) of group 3 and group 4.

In one example, sales lift estimation module 50 executes the inventory reallocation by distributing the number of the actual number of stocked units of product(s) of the first group and the second group among all of the products of the third group and the fourth group based on a ratio for each of the products of the third group and the fourth group equal to a total number of units of the product sold at any price divided by a total number of units sold of all of the products in the third and the fourth group. In the example in which sales lift estimation module 50 determines that a total of 125 units from group 1 and group 2 is added to the number of stocked units of product(s) of group 3 and group 4, sales lift estimation module 50 can distribute the units to the inventory of the products of groups 3 and 4 in proportion to the ratio of a total number of units of the product sold at any price divided by a total number of units sold of all of the products in the third and the fourth group.

For example, if the ration of a total number of units of a first product sold at any price divided by a total number of units sold of all of the products in the third and the fourth group is equal to 20%, then sales lift estimation module 50 can allocate 20% of the total 125 units to the first product to increase the inventory of the product by 25 units. In this example, the test number of stocked units of the first product is equal to the actual number of stocked units of the first product indicated by the past sales data plus the 25 units added. Sales lift estimation module 50 can distribute the total 125 units among the rest of the products in groups 3 and 4 in a similar fashion to determine the test number of stocked units of each of the products in the two groups.

After the test number of stocked units of each of the products is determined based on the reallocation of inventory, potential total sales of all of the products can be determined based on the test number of stocked units of each of the one or more products (106), as indicated in the example method of FIG. 3. For example, sales lift estimation module 50 of sales data module 46 determines potential total sales of all of the products based on the test number of stocked units of each of the products, the inventory of which has changed as a result of the reallocation.

As described above, product grouping module 48 divides and groups the products sold at the store of the retailer based on sell-through and sales volume for each of the products that is determined based on past sales data. Sales lift estimation module 50 then reallocates the number of units of one or more of the products to improve sales performance, e.g. by taking units of a first product sold at clearance and allocating them to another product that had 100% sell-through indicating that the inventory of the product may have been less than the customer demand for the product. After the reallocation process described above, e.g., in which sales lift estimation module 50 reduces the units of the products of groups 1 and 2 of FIG. 5 and increases the units of the products groups 3 and 4 in equal proportion, a number of the products are associated with a new test number of stocked units. Thus, some of the products included in the reallocation process may be associated with fewer stocked units, some products may be associated with more stocked units, and some products may be associated with the same number of units as the actual stocked units indicated by the sales data. Sales lift estimation module 50 can then calculate the potential total sales of all of the products based on the inventory levels of each of the products.

In one example, sales lift estimation module 50 calculates the potential total sales of all of the products based on the inventory levels of each of the products by assuming that all of the units added to the inventory of a product will be sold at full retail price. For example, referring to the example of FIGS. 6A and 6B, in the reallocation executed by sales lift estimation module 50 a number of the units of product A sold at clearance are taken from the inventory of product A and added to the inventory of product B. In one example, product A is a low sell-through and low-volume product and thus belongs to group 1 of FIG. 5. In one such case, sales lift estimation module 50 reallocates 50% of the clearance units of product A to the inventory level of product B. For example, the past sales data for product A indicates that 100 units of product A were sold at clearance price. Thus, in this example, sales lift estimation module 50 reallocates 50 of the clearance units of product A to the inventory level of product B to determine a test number of stocked units of product B that is equal to the actual number of stocked units indicated by the past sales data plus the additional 50 units reallocated from the inventory of product A. In this example, sales lift estimation module 50 can calculate the potential sales of product B by multiplying the retail price of product B by the test number of stocked units. Additionally, sales lift estimation module 50 can calculate the potential sales of product A by multiplying the retail price of product A by the actual number of units sold at retail price as indicated by the past sales data plus the actual number of units sold at clearance price minus the clearance units that were reallocated from product A to product B.

In another example, sales lift estimation module 50 calculates the potential total sales of all of the products based on the inventory levels of each of the products by assuming that some portion of the units added to the inventory of a product will be sold at reduced, e.g., clearance price. For example, sales lift estimation module 50 assumes that 10% of the units added to the inventory of a product will be sold at clearance price. Referring to the reallocation example of product A and product B again, sales lift estimation module 50 can calculate the sales of product B by multiplying the retail price of product B by a portion of the test number of stocked units and multiplying the clearance price of product by a portion of the test number of stocked units attributable to 10% of the units added from the inventory of product A. Thus, sales lift estimation module 50 multiplies the full retail price of product B by the actual number of stocked units indicated by the past sales data plus 90% or 45 units of the inventory of product A that was reallocated to the inventory of product B. Sales lift estimation module 50 multiplies the clearance price by 10% or 5 units of the inventory of product A that was reallocated to the inventory of product B. Sales lift estimation module 50 can then add these two products to determine the potential total sales of product B based on the test number of stocked units of the product.

In some examples, after determining potential total sales of all of the products based on the test number of stocked units of one or more of the products (106), sales lift estimation module 50 compares the potential total sales of the products to actual past sales to determine the potential incremental sales benefit that would result from reallocating the number of products stocked in the store. For example, sales lift estimation module 50 determines the difference between the potential total sales of the products and the actual past sales to determine the potential incremental sales increase that would result from reallocating the number of products stocked in the store. The retailer can use the determined potential incremental sales increase to inform inventory decisions at the store and generally to gauge the potential benefit of reallocating inventory among the products.

In some examples according to this disclosure, sales lift estimation module 50 or another module of a computing device, e.g., a reporting module is configured to generate a report representing the results of the inventory reallocation process. For example, sales lift estimation module 50 generates a report representing the test number of stocked units of each of products included in the inventory reallocation, the potential total sales of the products that results from inventory reallocation, as well as the actual total past sales of the products and the potential incremental sales benefit, e.g., increase in sales revenue and/or profit.

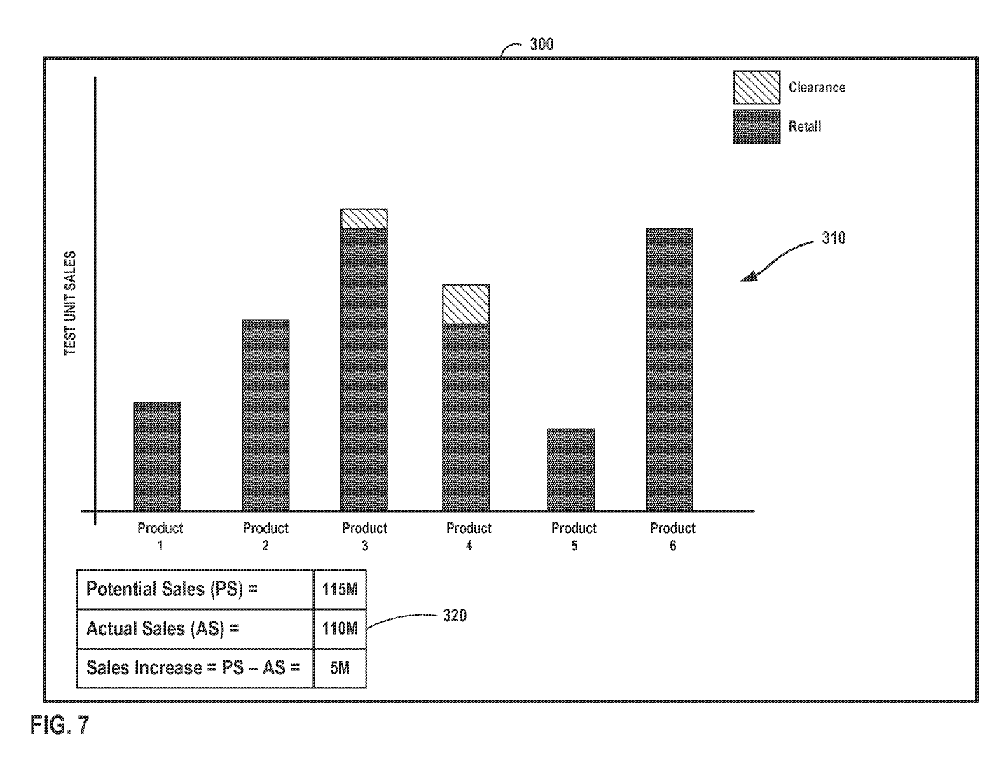

An example report generated by sales lift estimation module 50 is illustrated in FIG. 7. Report 300 includes histogram 310 representing the test number of stocked units of each of products 1-6. In report 300, the number of stocked units associated with each of products 1-6 may include fewer stocked units, more stocked units, or the same number of units as the actual stocked units indicated by the sales data for each of the products. In other words, some of products 1-6 may be associated with a reallocated inventory such that the number of units is more or less than the actual number of stocked units indicated by the sales data. Such products were subject to the reallocation process executed by sales lift estimation module 50, in which some of the actual number of stocked units were taken away from one product and reallocated to one or more other products based on sell-through and sales volume, as described above. However, in some cases, one or more of products 1-6 may be associated with the same number of units as the actual stocked units indicated by the sales data for each of the products. Such products may not have been subject to any inventory reallocation, whether adding or subtracting inventory, and, as such, the number of stocked units remains the same.

Report 300 also includes numerical representation 320 of the potential total sales of the products that results from inventory reallocation, the actual total past sales of the products, and the potential incremental sales increase (e.g., sales revenue and/or profit). In the example of FIG. 7, the reallocation of clearance units of one or more of products 1-6 to the stocked units of one or more other of products 1-6 based on sell-through and sales volume results in an increase of approximately 5 million dollars in sales revenue, which represents approximately a 3% increase over the actual total sales of all of the products indicated by the past sales data. The retailer can use report 300 or other such reports according to this disclosure as an efficient mechanism for gauging the potential benefit of reallocating inventory among the products at the store.

As noted above, the inventory reallocation process described above can be repeated for different groups of products, e.g., different product categories, different departments within a store, and the like. Additionally, the process can be repeated for all or a portion of the stores in the chain of retail stores operated by the retailer. The incremental sales increases determined in accordance with this disclosure can provide the retailer with a measurement of the potential benefit of changing the number of units of products allocated to different stores in the retail chain. And the retailer can weigh this benefit against any costs associated with implementing such inventory reallocation efforts.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

In some examples, computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
receiving, by a computing device, past sales data for a plurality of products associated with a retail store, wherein the sales data indicates, for each of the products, actual units stocked, a number of units sold at retail price, a number of units sold at reduced price, and a total number of units sold at any price;
dividing, by the computing device, the products into a plurality of groups based on at least one of the number of units sold at retail price, the number of units sold at reduced price, and the total number of units sold at any price for each of the products;
adding, by the computing device, a number of the actual stocked units of one or more of the products of one of the plurality of groups to the actual stocked units of one or more of the products of another of the plurality of groups to determine a test stocked units of each of the products; and
determining, by the computing device, potential total sales of all of the products based on the test stocked units of each of the one or more products.

2. The method of claim 1, wherein all of the products belong to one category of products sold in the same department of the retail store.

3. The method of claim 1, wherein dividing, by the computing device, the products into a plurality of groups comprises:
dividing, by the computing device, all of the products into two groups comprising high sell-through products and low sell-through products,
wherein the high sell-through products comprise one or more of the products with a sell-through that is greater than or equal to a sell-through threshold,
wherein the low sell-through products comprise one or more of the products with a sell-through that is less than the sell-through threshold, and
wherein sell-through is equal to a number of units of a product sold at retail price divided by a total number of units of the product sold at any price.

4. The method of claim 3, wherein dividing, by the computing device, the products into a plurality of groups comprises:
dividing, by the computing device, all of the products into two groups comprising high-volume products and low-volume products,
wherein the high-volume products comprise one or more of the products with a sales volume that is greater than or equal to a sales volume threshold,
wherein the low-volume products comprise one or more of the products with a sales volume that is less than the sales volume threshold, and
wherein sales volume is equal to a total number of units of a product sold at any price divided by a total number of units of all of the products sold.

5. The method of claim 4, further comprising:
grouping, by the computing device, the high sell-through products, the low sell-through products, the high-volume products, and the low-volume products into four groups comprising:
a first group comprising low sell-through and low-volume products;
a second group comprising low sell-through and high-volume products;
a third group comprising high sell-through and low-volume products; and
a fourth group comprising high sell-through and high-volume products.

6. The method of claim 5, wherein the sell-through threshold and the sales volume threshold each equal approximately 10%.

7. The method of claim 5, wherein adding, by the computing device, the number of the actual stocked units of one or more of the products of one of the plurality of groups comprises:
adding, by the computing device, a number of the actual stocked units of one or more of the products of the first group and the second group to the actual stocked units of the products of the third group and the fourth group to determine the test stocked units of each of the one or more products.

8. The method of claim 7, wherein adding, by the computing device, the number of the actual stocked units of one or more of the products of the first group and the second group to the actual stocked units of the products of the third group and the fourth group comprises:
distributing, by the computing device, the number of the actual stocked units of the one or more of the products of the first group and the second group among all of the products of the third group and the fourth group based on a ratio for each of the products of the third group and the fourth group equal to a total number of units of the product sold at any price divided by a total number of units of all of the products in the third and the fourth group sold.

9. The method of claim 7, wherein the number of the actual stocked units of the one or more of the products of the first group and the second group added to the actual stocked units of the products of the third group and the fourth group comprises:
50% of the number of units of the products in the first group sold at reduced price; and
100% of the number of units of the products in the second group sold at reduced price.

10. The method of claim 1, further comprising comparing the potential total sales of all of the products to actual total sales of all the products indicated by the past sales data.

11. The method of claim 10, wherein comparing the potential total sales of all of the products to the actual total sales of all the products comprises subtracting the actual total sales of all the products from the potential total sales of all of the products to determine a potential incremental sales increase.

12. The method of claim 11, further comprising generating a report representing at least one of:
the test stocked units of each of the one or more products;
the potential total sales of all of the products;
the actual total sales of all the products; and
the potential incremental sales increase.

13. The method of claim 11, wherein the report comprises:
a graphical representation of the test stocked units of each of the one or more products; and
a numerical representation of at least one of:
the potential total sales of all of the products;
the actual total sales of all the products; and
the potential incremental sales increase.

14. A computing device comprising:
at least one computer-readable storage device, wherein the at least one computer-readable storage device is configured to store sales data for a plurality of products associated with a retail store, wherein the sales data indicates characteristics of sales of the products; and
at least one processor configured to access information stored on the at least one computer-readable storage device and to perform operations comprising:
dividing the products into a plurality of groups based one or more characteristics of the products indicated by the sales data;
reallocating units of a first product of one of the groups to units of a second product of one of the other groups to determine a reallocated units stocked of each of the first and second products; and
determining potential sales of all of the products based at least in part on the reallocated units stocked of each of the first and second products.

15. The computing device of claim 14, wherein the characteristics of sales of the products indicated by the sales data comprises:
sell-through for each of the products; and
sales volume for each of the products,
wherein sell-through is equal to a number of units of a product sold at retail price divided by a total number of units of the product sold at any price, and
wherein sales volume is equal to a total number of units of a product sold at any price divided by a total number of units of all of the products sold.

16. The computing device of claim 15, wherein the at least one processor configured to:
divide all of the products into two groups comprising high sell-through products and low sell-through products; and
divide all of the products into two groups comprising high-volume products and low-volume products,
wherein the high sell-through products comprise one or more of the products with a sell-through that is greater than or equal to a sell-through threshold,
wherein the low sell-through products comprise one or more of the products with a sell-through that is less than the sell-through threshold,
wherein the high-volume products comprise one or more of the products with a sales volume that is greater than or equal to a sales volume threshold,
wherein the low-volume products comprise one or more of the products with a sales volume that is less than the sales volume threshold.

17. The computing device of claim 16, wherein the at least one processor configured to group the high sell-through products, the low sell-through products, the high-volume products, and the low-volume products into four groups comprising:
a first group comprising low sell-through and low-volume products;
a second group comprising low sell-through and high-volume products;
a third group comprising high sell-through and low-volume products; and
a fourth group comprising high sell-through and high-volume products.

18. The computing device of claim 16, wherein the at least one processor is configured to compare the potential total sales of all of the products to an actual total sales of all the products indicated by the sales data.

19. A computer-readable storage medium that includes instructions that, if executed by a computing device having one or more processors, cause the computing device to perform operations that include:
receiving sales data for a plurality of products associated with a retail store, wherein the sales data indicates sell-through and sales volume for each of the products, wherein sell-through is equal to a number of units of a product sold at retail price divided by a total number of units of the product sold at any price, and wherein sales volume is equal to a total number of units of a product sold at any price divided by a total number of units of all of the products sold;
dividing the products into a plurality of groups based on the sell-through and the sales volume of each of the products;
reallocating actual stocked units of a first product of one of the groups to actual stocked units of a second product of one of the other groups to determine a reallocated units stocked of each of the first and second products; and
determining potential sales of all of the products based at least in part on the reallocated units stocked of each of the first and second products.
